(19) United States
(12) Patent Application Publication
(10) Pub. No.: US 2009/0024591 A1
(43) Pub. Date: Jan. 22, 2009

(54) DEVICE, METHOD AND PROGRAM FOR PRODUCING RELATED WORDS DICTIONARY, AND CONTENT SEARCH DEVICE

(76) Inventors: Yasumasa MIYASAKA, Kanagawa (JP); Hajime Terayoko, Saitama (JP)

Correspondence Address: BIRCH STEWART KOLASCH & BIRCH, PO BOX 747, FALLS CHURCH, VA, 22040-0747, US

(21) Appl. No.: 12/175,352

(22) Filed: Jul. 17, 2008

(30) Foreign Application Priority Data
Jul. 18, 2007 (JP) 2007-187000

(51) Int. Cl. G06F 17/30

(52) U.S. Cl. 707/3; 707/104.1; 707/E17.009; 707/E17.014

(57) ABSTRACT

Image data from a client terminal is sent to a server along with its tags. In the server, hop number between the input tags or between the input tag and an accumulated tag that is added to image data accumulated in an image database is counted. Moreover, appearance frequency of the input tag is counted. Furthermore, entry sequence of the input tag is counted. When the hop number, appearance frequency and entry sequence are counted, evaluation values corresponding to the counted values and a reference value are integrated to calculate a score. The score is registered in the image database along with the combination of the tags.

### FIELD OF THE INVENTION

The present invention relates to a device, a method and a program for producing a related words dictionary that is used for searching content information, and also to a content search device.

### BACKGROUND OF THE INVENTION

A network system is often used to obtain desired content information, such as image data. In the network system, a client terminal accesses to a server that stores database and the database is searched based on a search word (keyword) input from the client terminal. When the input search word is appropriate, desired image data can be retrieved from the database. It is, however, difficult to choose the appropriate search word, and therefore the search is often continued, while changing the search word, until the desired image is obtained.

Related words dictionaries storing relevancy between words such as super-sub relation, part-whole relation, synonymous relation have recently been used to improve search accuracy. For example, United States Patent Application Publication No. 2005/0160460 corresponding to Japanese Patent Laid-Open Publication No. 2003-288359 discloses a content search device that retrieves related words of a search word from a related words dictionary when searching for content information to which metadata is added. This content search device uses not only the search word but also the related words to search for the content information.

Dictionaries are generally required to increase the number of words stored therein by registering new words. For the word registration, an input character string is divided into the parts of speech and those cannot be divided into the parts of speech are registered as unknown words in the dictionary. For this configuration, users do not have to register unknown words and therefore the number of words can be increased with ease (Japanese Patent Laid-Open Publications No. 11-085761 and 2004-265440).

Related words dictionaries are also required to register unknown words. In an information search device disclosed in Japanese Patent Laid-Open Publication No. 2002-230020, co-appearing words (related words) of a search word in a retrieved document are acquired in consideration of appearance frequency of the search word in the document when searching documents about multimedia information. When the acquired co-appearing words are not registered in a related words dictionary, they are newly registered as the related words in relation to the search word.

In the information search device of the Japanese Patent Laid-Open Publication No. 2002-230020, however, the operation for acquiring the co-appearing words from the document is necessary, and therefore the processing takes time. In addition, since unknown words not recognized as the related words are not registered, the system is not enough for increasing the number of words of the related words dictionary.

### SUMMARY OF THE INVENTION

It is a main object of the present invention to provide a device, a method and a program for producing a related words dictionary capable of registering unknown words with easy processing and effectively increasing the number of words stored in the related words dictionary.

It is another object of the present invention to provide a content search device capable of smoothly performing search of content information.

In order to achieve the above and other objects, a device for producing a related words dictionary of the present invention includes a metadata input section, a scoring section, and a related words registering section. The metadata input section inputs plural pieces of metadata added to content information. The scoring section determines a score representing a degree of relevancy between the metadata. The related words registering section registers a combination of the metadata and the score as being related to each other in the related words dictionary.

The scoring section may determine the score between the input metadata and metadata in the related words dictionary.

It is preferable that the related words dictionary producing device is provided with a content search section for searching content information having common metadata with the input metadata. The scoring section determines the score between the input metadata and metadata added to the searched content information.

It is preferable that the related words dictionary producing device is provided with a hop number counter for counting hop numbers of content information traceable via common metadata. The scoring section determines the score based on the hop numbers.

The scoring section may determine the score based on appearance frequency and/or rank of the metadata.

It is preferable that the related words dictionary producing device is provided with a word extractor for extracting words from a character string. The metadata input section inputs the extracted words as metadata.

It is preferable that the related words dictionary producing device is provided with a content collector for automatically collecting content information from a preliminary set data collecting location. The metadata input section inputs metadata added to the collected content information.

It is preferable that the related words dictionary producing device is provided with a content accumulating section for accumulating content information to which the metadata input from the metadata input section is added.

A method and a program for producing a related words dictionary of the present invention includes a metadata input step, a scoring step, and a related words registering step. In the metadata input step, plural pieces of metadata added to content information are input. In the scoring step, a score representing a degree of relevancy between the metadata is determined. In the related words registering step, a combination of the metadata and the score are registered as being related to each other in the related words dictionary.

A content search device of the present invention includes a metadata input section, a scoring section, a related words registering section, a content accumulating section, a search word input section, a related word search section, and a content search section. The metadata input section inputs plural pieces of metadata added to content information. The scoring section determines a score representing a degree of relevancy between the metadata. The related words registering section registers a combination of the metadata and the score as being related to each other to the related words dictionary. The content accumulating section accumulates content information to which the metadata input from the metadata input section is added. The search word input section inputs a search word. The related word search section searches related words from the related words dictionary. The content search section searches content information having the search word and at least one related word as the metadata from the content accumulating section.

At least one of the searched content information and its score are sent to the client terminal. In the client terminal, the content information with higher score is preferentially displayed on a monitor of the search word input section.

According to the present invention, plural pieces of metadata that are added to the content information are input, and the score representing the degree of relevancy between the metadata is determined, then the combination of the metadata and its score are registered as being related to each other in the related words dictionary. Owing to this, unknown words can be registered in the related words dictionary without any complicated processing.

In addition, since the content search device of the present invention uses the related words dictionary that registers unknown words with their scores, content information can be smoothly searched.

### BRIEF DESCRIPTION OF THE DRAWINGS

The above and other objects and advantages will be more apparent from the following detailed description of the preferred embodiments when read in connection with the accompanied drawings, wherein like reference numerals designate like or corresponding parts throughout the several views, and wherein:

FIG. 1 is a schematic diagram illustrating a structure of a network system of the present invention;

FIG. 2 is a block diagram illustrating an internal structure of a client terminal;

FIG. 3 is a block diagram illustrating an internal structure of a server;

FIG. 4 is a data table of image data and tags;

FIG. 5 is an explanatory view illustrating image data to which tags are added;

FIG. 6 is a table illustrating relations between words and scores;

FIG. 7 is an explanatory view illustrating relations of tags;

FIG. 8 is a table illustrating relations between hop numbers and evaluation values;

FIG. 9 is a table illustrating relations between appearance frequencies and evaluation values;

FIG. 10 is a table illustrating relations between entry sequences and evaluation values;

FIG. 11 is a table exemplifying relations between various evaluation values and the scores;

FIG. 12 is a flow chart explaining processing steps for registering combinations of tags and their scores in a dictionary DB;

FIG. 13 is a flow chart explaining processing steps for acquiring image data using the dictionary DB;

FIG. 14 is a block diagram illustrating an internal structure of a server according to a second embodiment of the present invention;

FIG. 15 is an explanatory view for extracting words from a character string; and

FIG. 16 is a flow chart explaining automatic collection of image data.

### DESCRIPTION OF THE PREFERRED EMBODIMENTS

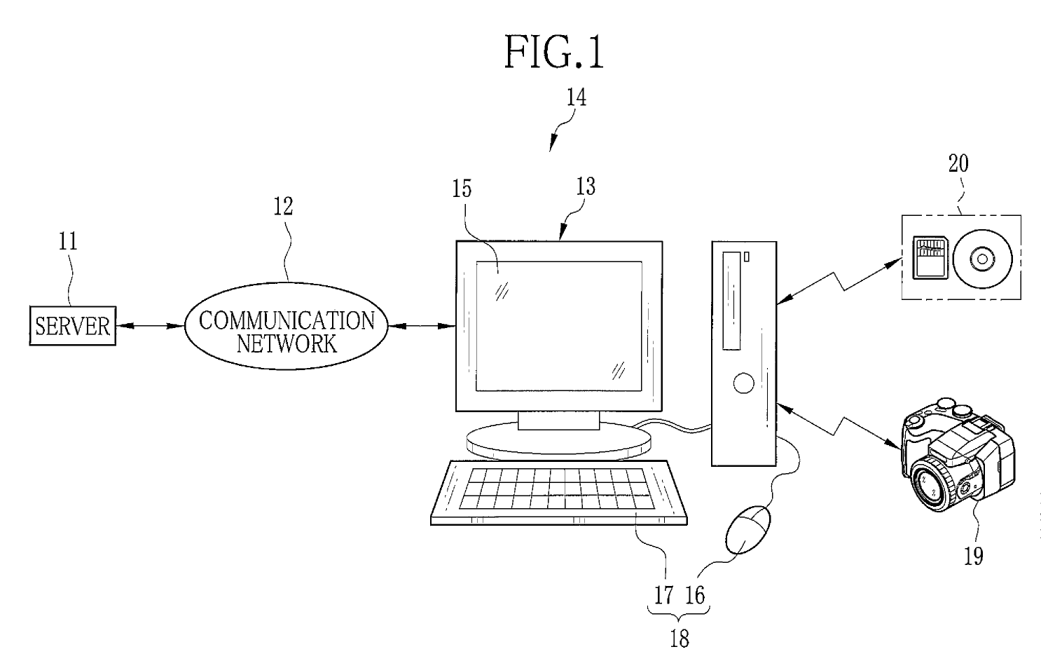

In FIG. 1, a network system 14 is constituted of a server 11 and client terminals 13 connected to the server 11 through communication networks 12. The server 11 works as a related words dictionary producing device and a content search device. A related words dictionary producing program recorded in a recording medium such as a CD-ROM is installed to the server 11.

The client terminal 13 is, for example, a well known personal computer or a work station, and has a monitor 15 for displaying various operating windows and an operating section 18 for inputting commands and the like. The operating section 18 has a mouse 16 and a keyboard 17.

To the client terminal 13, image data (corresponding to content information) obtained by photographing with a digital camera 19 and image data recorded in a recording medium 20 like a memory card or a CD-R are input. The client terminal 13 also sends image data to the server 11 through the communication network 12. The image data has tags in which metadata input from the operating section 18 are written. To retrieve desired content information, the metadata is searched by a search word input from the keyboard 17.

The digital camera 19 is connected to the client terminal 13 via a wireless LAN or a communication cable complying with, for example, IEEE 1394 or Universal Serial Bus (USB), and thereby communicating data with the client terminal 13. The recording medium 20 is also capable of communicating data with the client terminal 13 via a specific driver.

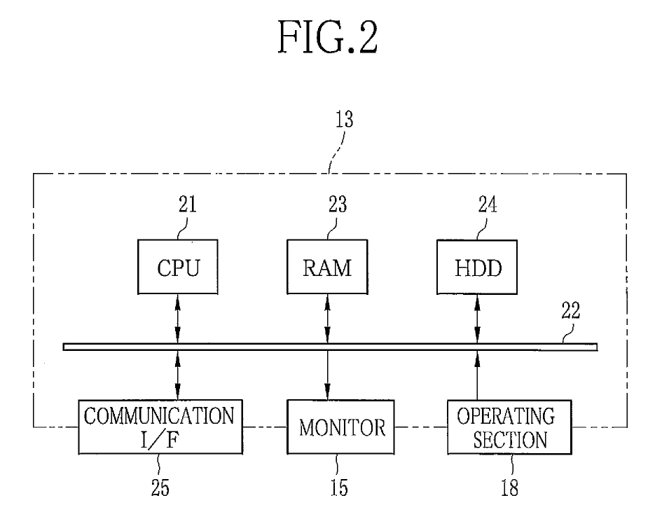

As shown in FIG. 2, the client terminal 13 is constituted of a CPU 21, the operating section 18, a RAM 23, a HDD 24, a communication I/F 25, and the monitor 15. These components are connected with each other via a data bus 22.

The PAM 23 is used as a work memory for the CPU 21 to execute processing. The HDD 24 stores various programs and data for operating the client terminal 13. The HDD 24 also stores image data loaded from the digital camera 19, the recording medium 20, and the communication network 12. The CPU 21 reads out the programs from the HDD 24 and deploys the programs in the RAM 23. The CPU 21 then sequentially executes the loaded programs.

The communication I/F 25 is, for example, a modem or a router that controls the communication protocol suitable for the communication network 12, and communicates data via the communication network 12. The communication I/F 25 also mediates the data communication of the client terminal 13 with external devices like the digital camera 19 and the recording medium 20.

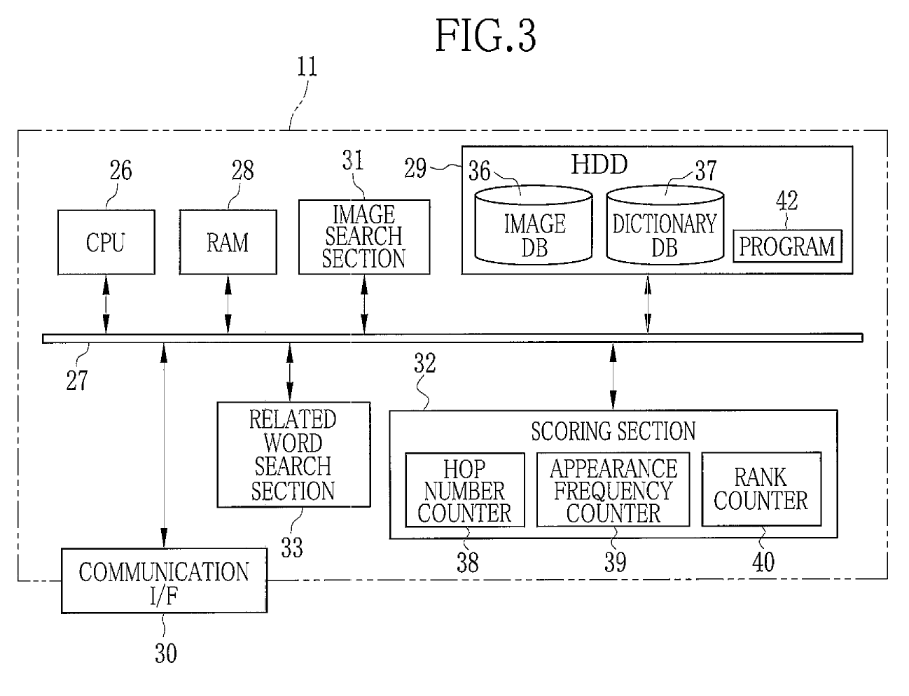

As shown in FIG. 3, the server 11 is constituted of a CPU 26, a RAM 28, a HDD 29, a communication I/F 30, an image search section (content search section ) 31, a scoring section 32, and a related word search section 33. These components are connected with each other via a data bus 27.

The CPU 26 entirely controls the server 11 according to operation signals coming from the client terminal 13 via the communication network 12. The RAM 28 is used as a work memory for the CPU 26 to execute processing. The HDD 29 stores various programs and data for operating the server 11. The HDD 29 also stores a related words dictionary producing program 42, a search program for searching content information, and the like. The CPU 26 reads out the programs from the HDD 29 and deploys the programs in the RAM 28. The CPU 26 then sequentially executes the loaded programs.

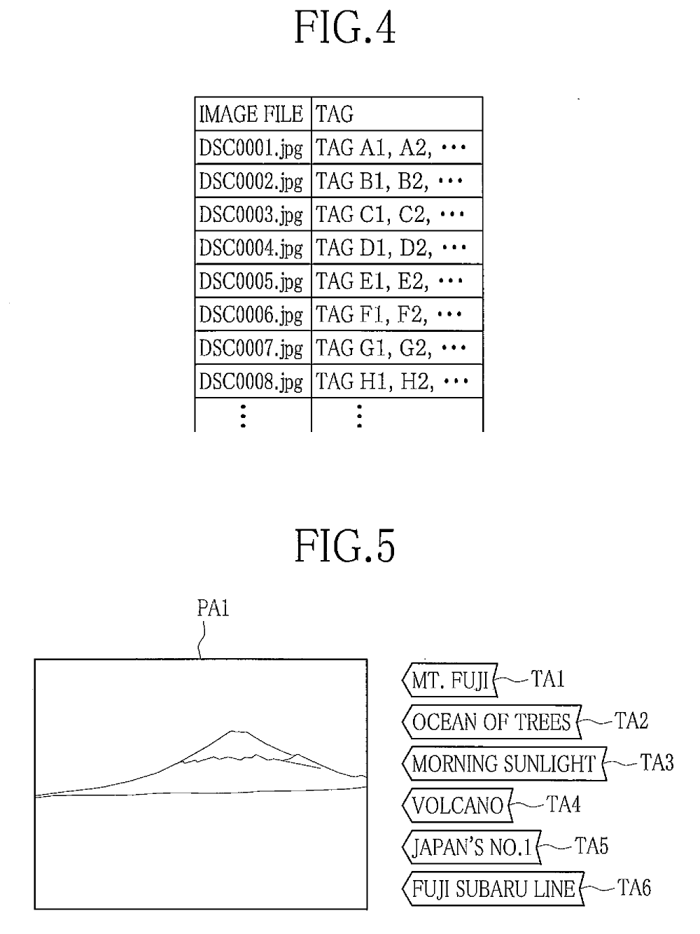

The HDD 29 contains an image database (image DB) 36 and a related words dictionary database (dictionary DB) 37. In the image DB 36, image data obtained via the communication network 12 and metadata written in tags that are added to these image data are stored. Hereinafter, the metadata is merely referred to as tag. As shown in FIG. 4, the image data and the tags related to each other are stored in data table form. Hereinafter, the image data stored in the image DB 36 is referred to as accumulated image data.

Examples of the accumulated image data and the tags are shown in FIG. 5. Image data PAT is a captured image of Mt. Fuji. To the image data PA1, tags TA1 “MT. FUJI”, TA2 “OCEAN OF TREES”, TA3 “MORNING SUNLIGHT”, TA4 “VOLCANO”, TA5 “JAPAN'S NO.1”, and TA6 “FUJI SUBARU LINE” are related.

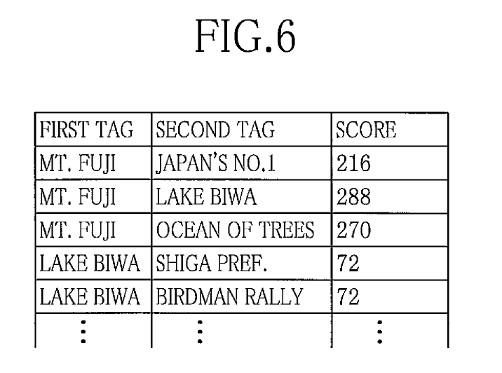

The dictionary DB 37 stores combinations of words as metadata written in the tags (hereinafter, referred to as tag) and scores representing relevancy between the tags. FIG. 6 shows an example of the dictionary DB 37 that includes combinations of first and second tags, and scores given to respective combinations. For example, the combination of “MT. FUJI” and “JAPAN'S NO.1” is given a score of “216”.

The communication I/F 30 is, for example, a modem or a router that controls the communication protocol suitable for the communication network 12, and communicates data via the communication network 12. Data obtained via the communication I/F 30 is temporarily stored in the RAM 28. When image data is obtained, the image data and its tags are stored in the RAM 28.

The CPU (metadata input section) 26 inputs the tags stored in the RAM 28 to the scoring section 32. The scoring section 32 determines a score between the input tags or between the input tag and a tag of the accumulated image data (accumulated tag).

The scoring section 32 is provided with a hop number counter 38, an appearance frequency counter 39, and a rank counter 40. The hop number counter 38 refers to the data table of the tag and counts the hop number of the accumulated tag counted from the input tag. The hop number is the number of the image data traceable via common tags. When there is a tag “A” among the tags of input image data, and also there is the tag “A” among the tags of accumulated image data, the number of traceable accumulated image data is “1”. Therefore, the hop number of the other tags of this accumulated image data is “1”. When there is a tag “B” among the tags of the accumulated image data having the tag of the hop number “1”, and also there is the tag “B” among the tags of another accumulated image data, two pieces of accumulated image data are traceable via the tags “A” and “B”. Therefore the hop number of the other tags of this second accumulated image data is “2”. The hop number between the tags of the identical image data is “0”.

The appearance frequency counter 39 counts the appearance frequency of each tag. Specifically, the relation between the accumulated tag and the number of times this tag is added is stored in the HDD 29 in data table form. When a newly input tag is same as one of the accumulated tags, the appearance frequency of the accumulated tag is incremented. When the newly input tag does not exist in the accumulated tags, the tag is stored with an appearance frequency of “1”.

The rank counter 40 counts the rank of each tag. The rank may be, for example, the entry sequence or the priority sequence designated by a user. In this embodiment, the entry sequence of the tag is designated as the rank.

The scoring section 32 calculates a score by multiplying a reference value by evaluation values. The evaluation values are obtained based on the numbers counted by the respective counters 38 to 40. Here, one of a pair of tags is defined as a first tag and the other is defined as a second tag. The score is calculated according to the following formula:

score=(reference value)×(evaluation value based on the hop number)×(evaluation value based on the appearance frequency of the first tag)×(evaluation value based on the appearance frequency of the second tag)×(evaluation value based on the entry sequence of the first tag)×(evaluation value based on the entry sequence of the second tag) (1)

The score gets higher as the relevancy between the tags becomes higher. Note that the reference value is arbitrary. The reference value in this embodiment is “1”.

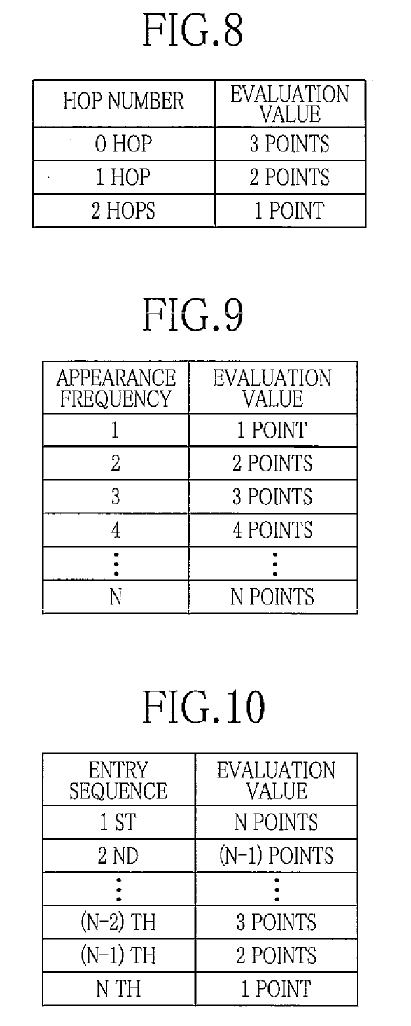

As shown in FIG. 8, evaluation values of the hop numbers are set as follows: “3” points for “0” hop, “2” points for “1” hop, and “1” point for “2” hops. These evaluation values are preliminary stored in the HDD 29. The evaluation value becomes lower as the hop number becomes larger and the relevancy between the tags becomes lower.

As shown in FIG. 9, evaluation values of the appearance frequencies are set as follows: “1” point for “1” time, “2” points for “2” times, “3” points for “3” times, “4” points for “4” times, . . . , and “N” points for “N” times (N: counting number). These evaluation values are preliminary stored in the HUD 29. The evaluation value becomes higher as the appearance frequency becomes higher.

As shown in FIG. 10, evaluation values of the entry sequences are set as follows: “N” point for “1st”, “(N−1)” point for “2nd”, . . . , “3” points for “(N−2)th”, “2” points for “(N−1)th”, and “1” point for “Nth” (N: counting number). These evaluation values are preliminary stored in the HDD 29. The evaluation value becomes lower in the order of the entry sequence.

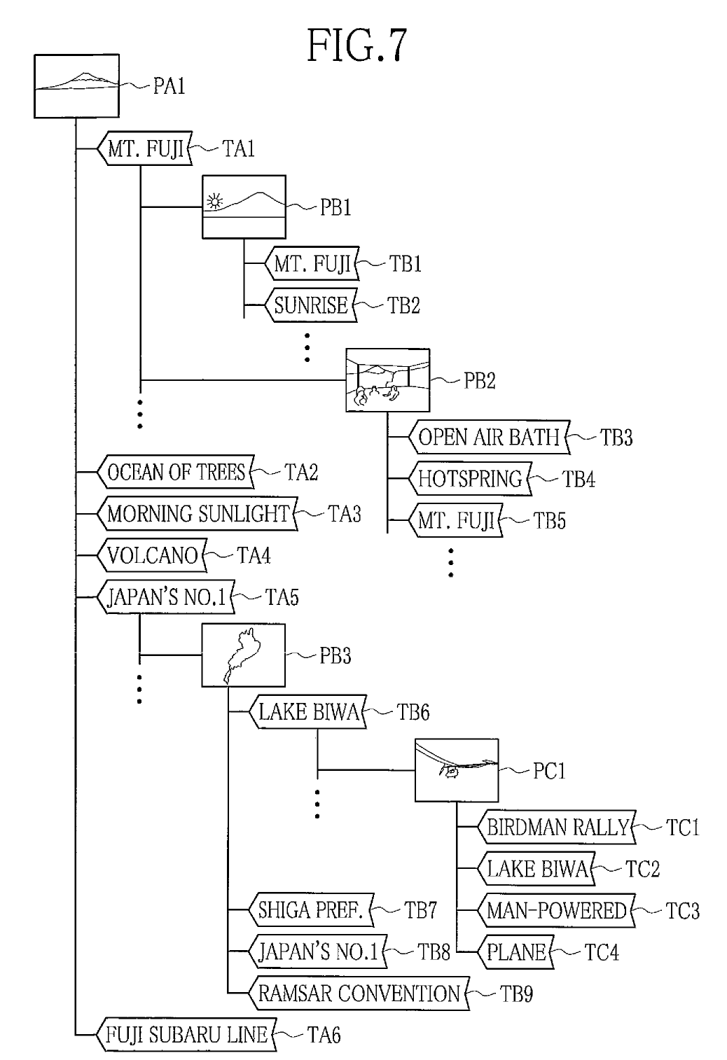

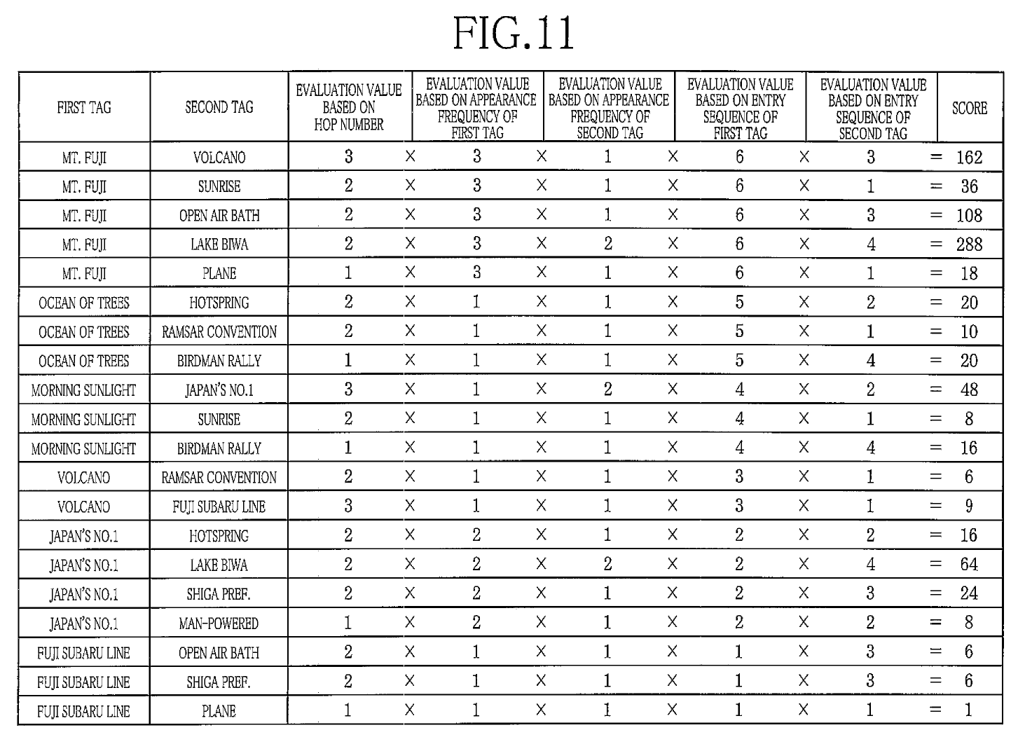

The operation of the scoring section 32 is explained with referring to FIGS. 7 and 11. In FIG. 7, the tags TAT “MT. FUJI”, TA2 “OCEAN OF TREES”, TA3 “MORNING SUNLIGHT”, TA4 “VOLCANO”, TA5 “JAPAN'S NO.1”, and TA6 “FUJI SUBARU LINE” are added to the identical image data PA1. Therefore, the hop number between each of these tags is “0”. Accumulated tags TB2 “SUNRISE”, TB3 “OPEN AIR BATH”, TB4 “HOTSPRING”, TB6 “LAKE BIWA”, TB7 “SHIGA PREF.”, and TB9 “RAMSAR CONVENTION” are traceable from the tag TA1, and tags TB1 and TB5 “MT. FUJI”, and from the tag TA5 and a tag TB8 “JAPAN'S NO.1”. Therefore, the hop number of the tags TB2, TB3, TB4, TB6, TB7, and TB9 are respectively “1” counted from the tags TA1 to TA6. TC1 “BIRDMAN RALLY”, TC3 “MAN-POWERED”, and TC4 “PLANE” are traceable from the tag TB6 and a tag TC2 “LAKE BIWA”. Therefore the hop number of the tags TC1, TC3, and TC4 are respectively “2”]counted from the tags TA1 to TA6.

When it is assumed that tags not shown in the drawing are not accumulated in the image DB 36, the number counted by the appearance frequency counter 39 for “MT. FUJI” is “3”, for “JAPAN'S NO. 1” is “2”, for “LAKE BIWA” is “2”, and “1” for others.

When the tags are aligned from up to down in the order of entry sequence, the number counted by the rank counter 40 for “MT. FUJI” is “1st”, for “OCEAN OF TREES” is “2nd”, . . . , for “FUJI SUBARU LINE” is “Nth”.

Scores are calculated according to the formula (1) on the basis of the above. The calculated scores are shown in FIG. 11. The score of the combination of “MT. FUJI” and “VOLCANO” is explained as an example. The hop number of “MT. FUJI” and “VOLCANO” is “0”, and therefore the evaluation value based on this hop number is “3”. The appearance frequency of “MT. FUJI” is “3”, and therefore the evaluation value thereof is “3”, meanwhile the appearance frequency of “VOLCANO” is “1”, and therefore the evaluation value thereof is “1”. The entry sequence of “MT. FUJI” is first among the six tags, and therefore the evaluation value thereof is “6”, meanwhile the entry sequence of “VOLCANO” is fourth among the six tags, and therefore the evaluation value thereof is “3”. Accordingly, the score of the combination of “MT. FUJI” and “VOLCANO” is 162 (=3×3×1×6×3). Note that the “evaluation value based on the appearance frequency” and “evaluation value based on the entry sequence” are calculated based on the assumption that no tags other than those shown in FIG. 7 exist.

Scores of other combinations are also calculated in the same manner. For example, the score of the combination of “MT. FUJI” and “SUNISE” is 36 (=2×3×1×6×1), and the score of the combination of “FUJI SUBARU LINE” and “PLANE” is 1 (=1×1×1×1×1).

The combinations of the tags and their scores are registered in the dictionary DB 37. When the combination of the tags is already registered, only the score is overwritten. When there is an unknown word among the input tags, the combination with that unknown word and its score is newly registered.

Referring back to FIG. 3, the CPU (search word input section) 26 inputs the search word entered from the client terminal 13 to the related word search section 33. The related word search section 33 searches the dictionary DB 37 for related words based on the search word. The related word search section 33 acquires the related words and their scores.

The image search section 31 searches the image DB 36 for the accumulated image data having the tags in which the search word and all or at least one of its related words are written as metadata. The image search section 31 reads out this accumulated image data to the RAM 28. The image data read out in the RAM 28 is then sent to the client terminal 13 via the communication network 12.

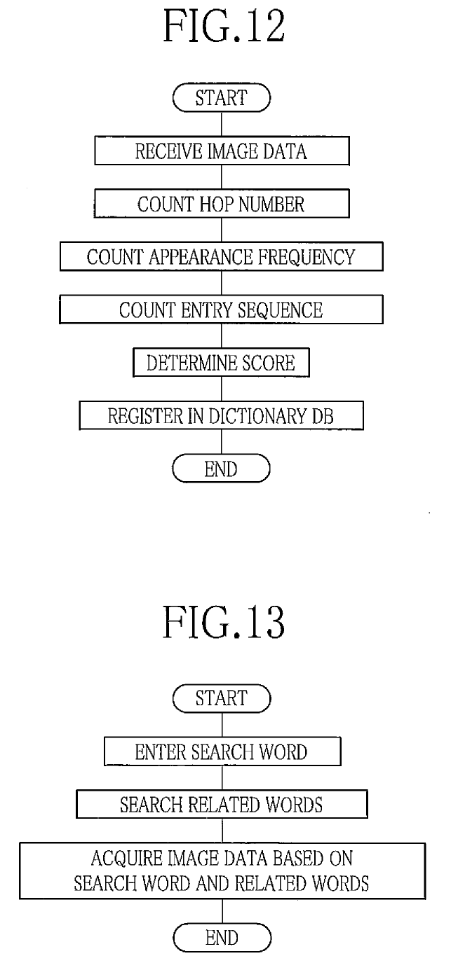

Hereinafter, the operation of the network system 14 according to the above first embodiment is explained. The client terminal 13 adds tags to the image data stored in the HDD 24 and sends the image data with the tags to the server 11. In the tags, metadata input from the operating section 18 are written. As shown in FIG. 12, the image data and the tags sent to the sever 11 are received by the communication I/F 30 and stored in the RAM 28.

The tags stored in the RAM 28 (input tags) are read out to the scoring section 32. In the scoring section 32, the hop number counter 38 counts the hop number between the input tags or between the input tag and the accumulated tag that is added to the image data accumulated in the image DB 36. Moreover, the appearance frequency counter 39 counts the appearance frequency of each tag. Furthermore, the rank counter 40 counts the entry sequence of each tag.

After counting the hop number, appearance frequency and entry sequence, the scoring section 32 reads out the evaluation values corresponding to the respective counted values from the HDD 29 and calculates scores by multiplying a reference value by the evaluation values. The combinations of the tags and their scores are registered in the dictionary DB 37.

When image data is searched, as shown in FIG. 13, a search word is entered from the operating section 18 of the client terminal 13. The search word is sent to the sever 11 via the communication network 12. The search word received by the server 11 is stored in the RAM 28 via the communication I/F 30.

The search word stored in the RAM 28 is read out to the related word search section 33. The related word search section 33 searches the dictionary DB 37 for related words of the search word, and acquires the related words with their scores. The image search section 31 searches among the accumulated image data for the image data having the tags in which the search word and all or at least one of the related words are written as metadata, and extracts the corresponding image data. The extracted image data is sent to the client terminal 13 via the communication network 12 and displayed as the search result on the monitor 15.

When plural pieces of image data are extracted, the image data are sent with their scores to the client terminal 13. In the client terminal 13, the plural pieces of image data are displayed in, for example, decreasing order of scores on the monitor 15. It is also possible that the plural pieces of image data are classified into groups according to their score rankings. In this case, plural images are displayed side by side on a screen of the monitor 15 by group. The images of each group are displayed by turns. Images with many related words added thereto have higher scores, and therefore the images with higher relevancy can be preferentially displayed.

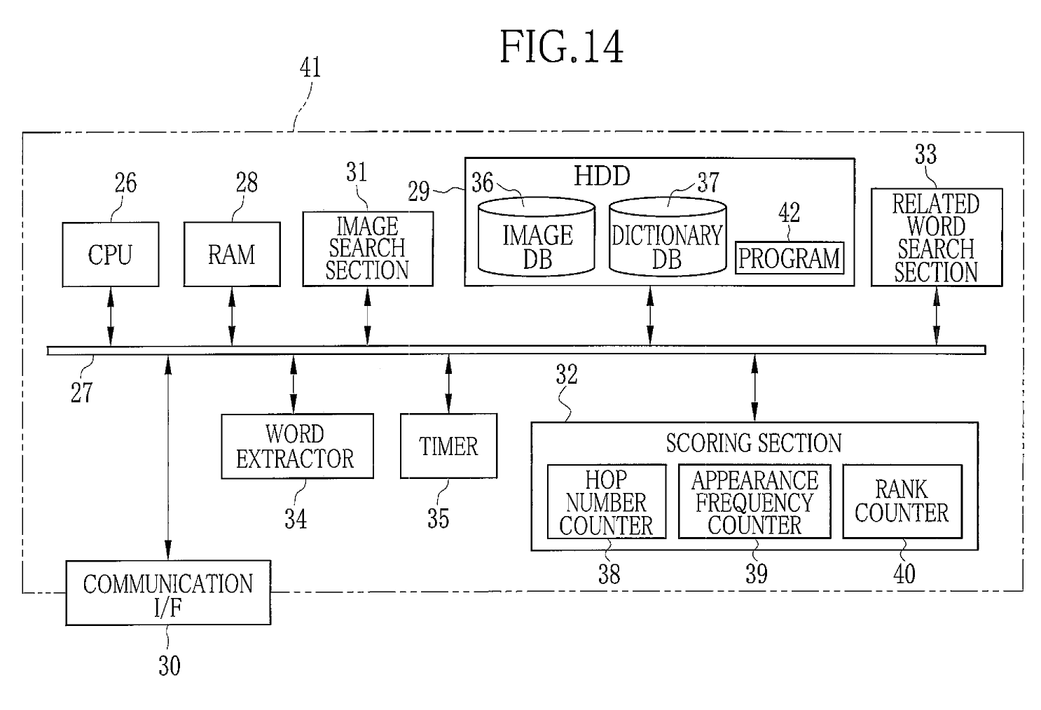

In the first embodiment, metadata is written in the tag of the image data. In a second embodiment, a character string (text data) is added to the image data. The second embodiment of the present invention is explained with referring to FIGS. 14, 15 and 16.

A network system according to the second embodiment has a server 41 instead of the server 11 of the network system 14 shown in FIG. 1. As shown in FIG. 14, a word extractor 34, a timer 35 and the like are connected to the CPU 26 constituting the server 41 via the data bus 27. The word extractor 34 analyzes text data added to the image data and extracts words. Note that the same components as the network system 14 of the first embodiment are assigned with the same numerals, and therefore the detailed explanations thereof are omitted.

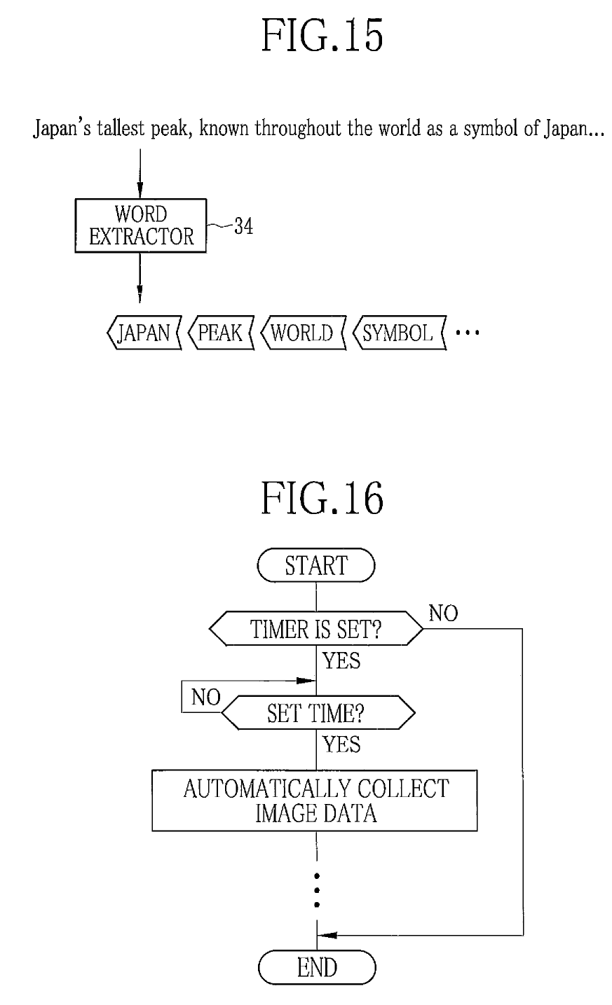

As shown in FIG. 15, image data (input image data) and its text data are written to the RAM 28 via the communication I/F 30. When the text data “Japan's tallest peak, known throughout the world as a symbol of Japan . . . ” is read out, the word extractor 34 analyzes this text data and extracts words “JAPAN”, “PEAK”, “WORLD” and “SYMBOL”. As a method for extracting words, the morphologic analysis using a word list is applicable. The morphologic analysis is a well known technique, and therefore the detailed explanation thereof is omitted.

The CPU (metadata input section) 26 inputs the words (metadata) extracted by the word extractor 34 to the scoring section 32. The scoring section 32 determines a score between the input words or between the input word and the accumulated tag added to the image data accumulated in the image DB 36.

The timer 35 manages the time inside the server 11. The CPU (content collector) 26 automatically collects image data from a preliminary set data collecting location at a time preliminary set by the timer 35. The image data collected via the communication I/F 30 is stored in the RAM 28. Owing to this, the related words can be automatically registered in the dictionary DB 37 without operations by the user. It is of course possible to receive image data from the client terminal 13 like the first embodiment.

Hereinafter, the operation of the network system according to the second embodiment is explained. As shown in FIG. 16, when the timer 35 is set, the CPU 26, working as the content collector, automatically collects image data from the preset data collecting location at the preset time, and stores the collected image data in the RAM 28. The tags stored in the RAM 28 (input tags) are read out to the scoring section 32, and scores of the tags are determined.

When the image data stored in the RAM 28 has the text data, the text data is read out to the word extractor 34 and analyzed for extracting words. The extracted words are read out to the scoring section 32. The scoring section 32 determines a score between the input words or between the input word and the accumulated tag added to the image data accumulated in the image DB 36.

When a search word is entered from the client terminal 13 for searching the image data, the image searching section 31 searches for the image data with text data that includes both the search word and its related words. The hit image data is sent from the server 41 to the client terminal 13 and displayed as the search result on the monitor 15. When plural pieces of image data are retrieved, plural images may be displayed in decreasing order of scores on the monitor 15 like the first embodiment.

Although the content information are still images in the above embodiments, the content information may also be moving images, music, games, electronic books, web pages, and so on. Although one piece of image data is input in the above embodiments, plural pieces of image data can be input.

In the above embodiments, the scoring section 32 determines the score between the input tags or between the input tag and the accumulated tag. However, it is also possible that the score is determined only between the input tags. In this case, the image DB 36 for accumulating image data is unnecessary.

In the above embodiments, the image searching section 31 searches the image DB 36 in the server 11 for image data. However, it is also possible that the image searching section 31 searches any sites connected via the communication network 12 for image data.

In the above embodiments, tags with hop number at most “2” are evaluated and registered in the dictionary DB 37. However, the tags with hop number “3” or more can also be evaluated. When tags with hop number “N” are evaluated, the evaluation values are set as follows: “(N+1)” points for “1” hop, “N” points for “1” hop, “(N−1)” points for “2” hops, . . . , “2” points for “(N−1)” hop, and “1” point for “N” hops (N: counting number).

In the above embodiments, scores are calculated by multiplying the reference number by the evaluation values according to the hop number, appearance frequency and entry sequence. Scores may be calculated by other arithmetic expressions. For example, scores may be obtained by adding respective evaluation values. In this case, each evaluation value is preferably weighted differently and added.

In the above embodiments, the evaluation value of the hop number is set to be decreased for “1” point every time the hop number is incremented by “1”. However, the hop number's increment needs not be proportional to the point's decrease as long as the point decreases as the hop number becomes larger and the relevancy between the tags becomes lower.

In the above embodiments, the evaluation value of the appearance frequency is set to be increased for “1” point every time the number of appearance is incremented by “1”. However, the appearance frequency needs not be proportional to the point as long as the point increases as the appearance frequency becomes higher.

In the above embodiments, the evaluation value of the entry sequence is set to be decreased for “1” point every time the rank gets lower by “1”. However, the entry sequence's decrease needs not be proportional to the point's decrease as long as the point decreases as the rank becomes lower.

In the above embodiments, scores are calculated based on all of the evaluation values of the hop number, appearance frequency and entry sequence. However, it is possible that the scores are calculated based on the evaluation value of one of the hop number, appearance frequency and entry sequence, or on the evaluation values of two of them.

In the above embodiments, the input image data is temporarily stored in the RAM 28 to apply various processing to the data. After the processing, the image data may be accumulated in the image DB 36.

In the above embodiments, the accumulated tag and the number of times this tag is added is stored in the HDD 29 in data table form, and the appearance frequencies of all the accumulated tags are counted. However, it is possible to limit the tags to, for example, those traceable within the hop number of “2” from the input tag for counting the appearance frequency.

Specifically, the image search section 31 searches the image DB 36 for accumulated image data having the tag same as the input tag. The retrieved image data and its accumulated tags having the hop number “1” are stored in the RAM 28. The image search section 31 also searches the image DB 36 for accumulated image data having the tags same as the tags with the hop number “1” stored in the RAM 28. The retrieved image date and its accumulated tags having the hop number “2” are stored in the RAM 28. The hop counter 38 counts the input tag stored in the RAM 28 and the accumulated tags with the hop number “1” or “2”. Owing to this, the appearance frequency of tags that are traceable within the hop number of “2” from the input tag can be counted. Note that the accumulated tags can be limited to those traceable within the hop number of “0” or “1”, or “3” or more.

When displaying image data as the search result on the monitor 15, it is possible to sort the accumulated image data. The image data may be sequentially sorted such that those having related words of higher scores as tags are preferentially displayed. The image data may also be sorted such that those having higher number of related words are preferentially displayed. The sorted image data are displayed on the monitor 15 in any ways such as from top to bottom or from center to periphery so as to appropriately show their sorted order.

In the second embodiment, the word extractor 34 extracts words by analyzing the text data added to the image data. However, the analyzed text data is not limited to those added to the image data. For example, metadata added by inputting from the keyboard may be included.

Various changes and modifications are possible in the present invention and may be understood to be within the present invention.

What is claimed is:

1. A device for producing a related words dictionary storing relevancy between words comprising:
a metadata input section for inputting plural pieces of metadata added to content information;
a scoring section for determining a score representing a degree of relevancy between said metadata; and
a related words registering section for registering a combination of said metadata and said score as being related to each other in said related words dictionary.

2. The device according to claim 1, wherein said scoring section determines said score between said input metadata and metadata in said related words dictionary.

3. The device according to claim 2, further comprising:
a content search section for searching content information having common metadata with said input metadata, wherein
said scoring section determines said score between said input metadata and metadata added to the searched content information.

4. The device according to claim 1, further comprising:
a hop number counter for counting hop numbers of content information traceable via common metadata,
wherein said scoring section determines said score based on said hop numbers.

5. The device according to claim 1, wherein said scoring section determines said score based on appearance frequency of said metadata.

6. The device according to claim 1, wherein said scoring section determines said score based on rank of said metadata.

7. The device according to claim 1, further comprising:
a word extractor for extracting words from a character string,
wherein said metadata input section inputs the extracted words as metadata.

8. The device according to claim 1, further comprising:
a content collector for automatically collecting content information from a preliminary set data collecting location,
wherein said metadata input section inputs metadata added to the collected content information.

9. The device according to claim 1, further comprising:
a content accumulating section for accumulating content information to which said metadata input from said metadata input section is added.

10. A method for producing a related words dictionary storing relevancy between words comprising the steps of:
inputting plural pieces of metadata added to content information;
determining a score representing a degree of relevancy between said metadata; and
registering a combination of said metadata and said score as being related to each other in said related words dictionary.

11. A program for a computer to produce a related words dictionary storing relevancy between words comprising the steps of:
inputting plural pieces of metadata added to content information;
determining a score representing a degree of relevancy between said metadata; and
registering a combination of said metadata and said score as being related to each other in said related words dictionary.

12. A content search device comprising:
a metadata input section for inputting plural pieces of metadata added to content information;
a scoring section for determining a score representing a degree of relevancy between said metadata;
a related words registering section for registering a combination of said metadata and said score as being related to each other in said related words dictionary;
a content accumulating section for accumulating content information to which said metadata input from said metadata input section is added;
a search word input section for inputting a se-arch word;
a related word search section for searching related words from said related words dictionary; and
a content search section for searching content information having said search word and at least one said related word as said metadata from said content accumulating section.

13. The content search device according to claim 12, wherein when plural pieces of content information are retrieved, said plural pieces of content information are displayed in the order of decreasing priorities according to said score on a monitor of said search word input section.
